(19) United States
(12) Patent Application Publication
(10) Pub. No.: US 2001/0035074 A1
(43) Pub. Date: Nov. 1, 2001

(54) Positioning device for a switch member of a reversible ratchet-type wrench

(76) Inventor: Bobby Hu, Taichung (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/814,430

(22) Filed: Mar. 21, 2001

(30) Foreign Application Priority Data
Jul. 21, 2000 (TW) 89212815

(51) Int. Cl. B25B 13/46

(52) U.S. Cl. 81/63

(57) ABSTRACT

A reversible ratchet-type wrench includes a handle and a head extended from the handle. A web defined between the handle and the head includes a cavity communicated with a hole of the head and a receiving hole communicated with the cavity. An inner periphery defining the receiving hole includes a first positioning notch and a second positioning notch. A pawl is mounted in the cavity and includes a first side with teeth for meshing with teeth of a drive member rotatably mounted in the hole of the head. A switch member includes a turn-piece outside the receiving hole of the web for manual operation. The switch member further includes a positioning section extending from the turn-piece and a switching section extending from the positioning section. The positioning section is rotatably received in the receiving hole of the web and has a positioning member retained in one of the first positioning notch and the second positioning notch of the receiving hole of the web. A biasing/actuating member has a first end attached to the positioning section of the switch member and a second end attached to a second side of the pawl for biasing the teeth of the first side of the pawl to engage with the teeth of the drive member.

### BACKGROUND OF THE INVENTION

1. Field of the Invention

The present invention relates to a positioning device for a switch member of a reversible ratchet-type wrench.

2. Description of the Related Art

U.S. Pat. No. 2,957,377 issued to Hare on Oct. 25, 1960 discloses a reversible ratchet type wrench comprising a body 10 having a handle 11 and a head 12. A cap 39 and an annular wall 44 are provided to upper side and lower side of the head 12, respectively. Yet, this increases the assembly time and the manufacture cost and adversely affects the appearance. A shifting lever 35 is retained in place by a spring 33 that is located in a cylindrical opening 34. Nevertheless, formation of the cylindrical opening 34 that extends at an incline upward is relatively difficult. In addition, formation of the cavity 16 having converging straight sides 17, 18 which diverge in the direction of the periphery of rotatable member 14 requires expensive and accurate computer-numeric-control (CNC), which further results in an increase in the cost together with a low production rate. This is why such a reversible ratchet type wrench is hardly seen in the market.

FIGS. 9 and 10 illustrate another conventional ratchet type wrench comprising a handle 12′ and a head 11′. The head 11′ is machined to form four consecutive compartments for receiving the drive member 20′, the pawl 30′ and the shifting lever 40′, wherein three of the compartments can be formed by cutting, yet the remaining one must be machined by CNC. Further, the resultant head structure is relatively weak and thus has a poor torque-bearing capacity. In addition, the movement of the pawl 30′ for changing ratcheting direction is found unreliable, as it is achieved via transmission of the hook end 442′ of a spring 44′ attached to the shifting lever 40′.

### SUMMARY OF THE INVENTION

It is the primary object of the present invention to provide a positioning device for a switch member of a reversible ratchet-type wrench. The resultant ratchet-type wrench is easy to manufacture and assemble.

It is another object of the present invention to provide a reversible ratchet-type wrench that can be manufactured within a relatively short period of time at low cost without using computer-controlled lathes.

A reversible ratchet-type wrench in accordance with the present invention comprises:

a handle;

a head extended from the handle and having a hole, a web being defined between the handle and the head, the web including a cavity communicated with the hole of the head and a receiving hole communicated with the cavity, an inner periphery defining the receiving hole including a first positioning notch and a second positioning notch;

a drive member rotatably mounted in the hole of the head and including a plurality of teeth defined in an outer periphery thereof;

a pawl mounted in the cavity and including a first side facing the hole of the head and a second side facing away from the hole of the head, the first side of the pawl including a plurality of teeth for meshing with the teeth of the drive member;

a switch member including a turn-piece outside the receiving hole of the web for manual operation, the switch member further including a positioning section extending from the turn-piece and a switching section extending from the positioning section, the positioning section being rotatably received in the receiving hole of the web and having a positioning member retained in one of the first positioning notch and the second positioning notch of the receiving hole of the web, the turn-piece being movable to move the positioning member into one of the first positioning notch and the second positioning notch; and

a biasing/actuating means having a first end attached to the positioning section of the switch member and a second end attached to the second side of the pawl for biasing the teeth of the first side of the pawl to engage with the teeth of the drive member;

wherein when the positioning member is retained in the first positioning notch of the receiving hole of the web, the wrench allows ratcheting in a first direction, and when the positioning member is retained in the second positioning notch of the receiving hole of the web, the wrench allows ratcheting in a second direction that is reverse to the first direction.

The receiving hole is a cylindrical hole extending along a direction that is perpendicular to a longitudinal axis of the handle. The second side of the pawl includes a recess. An inner wall defining the recess includes an arcuate groove for receiving the second end of the biasing/actuating means. The biasing/actuating means includes an actuating member and an elastic member. The actuating member has a wider middle portion, a first end, and a second end. The elastic member includes a first end attached to the first end of the actuating member and a second end attached to the switching section of the switch member. The second end of the actuating member is biased by the elastic member into the arcuate groove of the pawl. The second end of the actuating member is round. The switching section of the switch member includes a receptacle for receiving the second end of the elastic member. Two reinforcing pieces project outward from an area that surrounds an end of the receptacle, and the middle portion of the actuating member are guided between the reinforcing pieces.

The positioning section of the switch member includes two opposite flat sides to allow slight sliding movement of the switch member in the receiving hole of the web. Each of the two positioning notches includes an inclined section adjacent to the other positioning notch to guide the positioning member out of one of the positioning notches and into the other positioning notch.

An inner periphery defining the hole of the head includes an annular groove. The outer periphery of the drive member includes an annular groove. A C-clip is received in the annular groove of the head and the annular groove of the drive member, thereby rotatably mounting the drive member in the head. The drive member may be a gear wheel.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an end portion of a ratchet-type wrench in accordance with the present invention.

FIG. 2 is an exploded perspective view of the end portion of the ratchet-type wrench in accordance with the present invention.

FIG. 3 is a longitudinal sectional view of the end portion of the ratchet-type wrench in accordance with the present invention.

FIG. 4 is a side view of a switch member in accordance with the present invention.

FIG. 4a is a sectional view taken along line A-A in FIG. 4.

FIG. 4b is a sectional view taken along line B-B in FIG. 4.

FIG. 4c is a sectional view taken along line C-C in FIG. 4.

FIG. 5 is a sectional view taken along line 5-5 in FIG. 3.

FIG. 5a is an enlarged sectional view of the switch member in FIG. 5.

FIG. 5b is a sectional view similar to FIG. 5a, illustrating switching of the switch member.

FIG. 5c is a sectional view similar to FIG. 5c, wherein the switch member is retained in another position.

FIG. 6 is a sectional view similar to FIG. 5, wherein the switch member is retained in another position.

FIG. 7 is a sectional view taken along line 7-7 in FIG. 3.

FIG. 8 is a sectional view similar to FIG. 7, wherein the switch member is retained in another position.

FIG. 9 is an exploded perspective view of a conventional ratchet type wrench.

FIG. 10 is a sectional view of a head of the conventional ratchet type wrench in FIG. 9.

### DETAILED DESCRIPTION OF THE PREFERRED EMBODIMENT

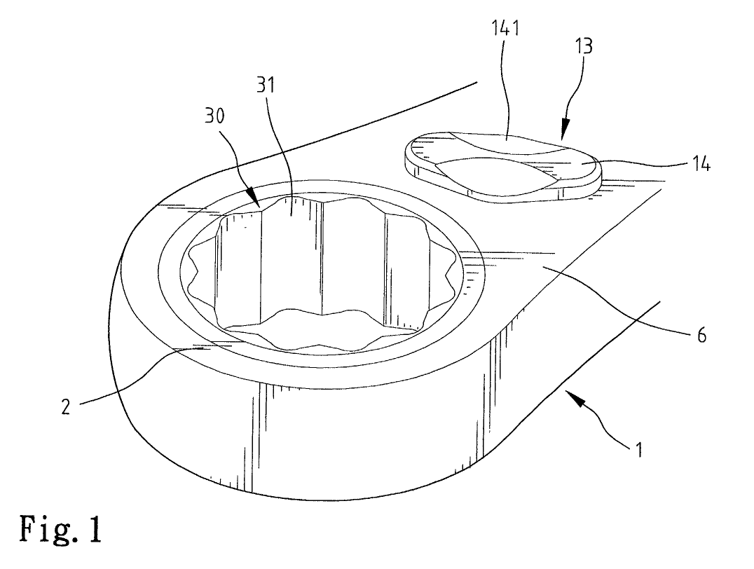

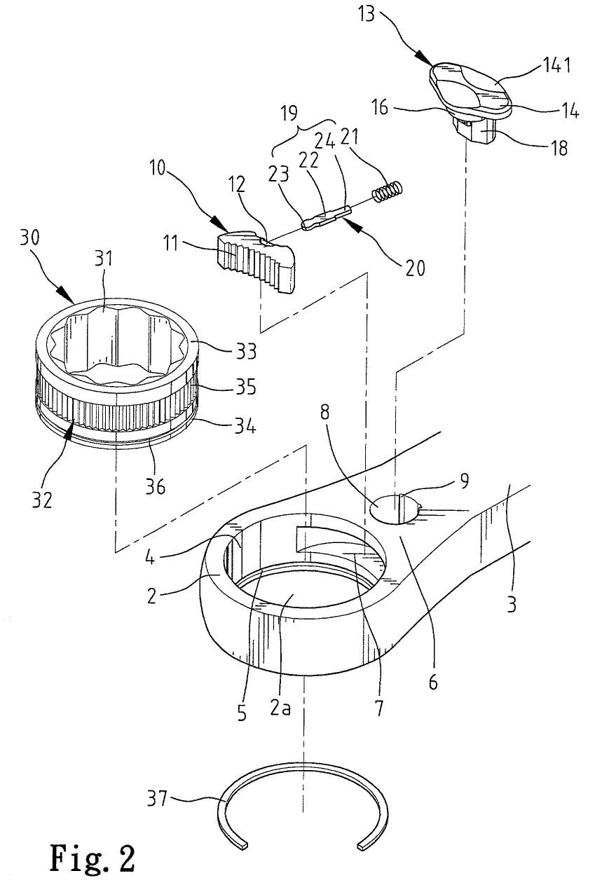

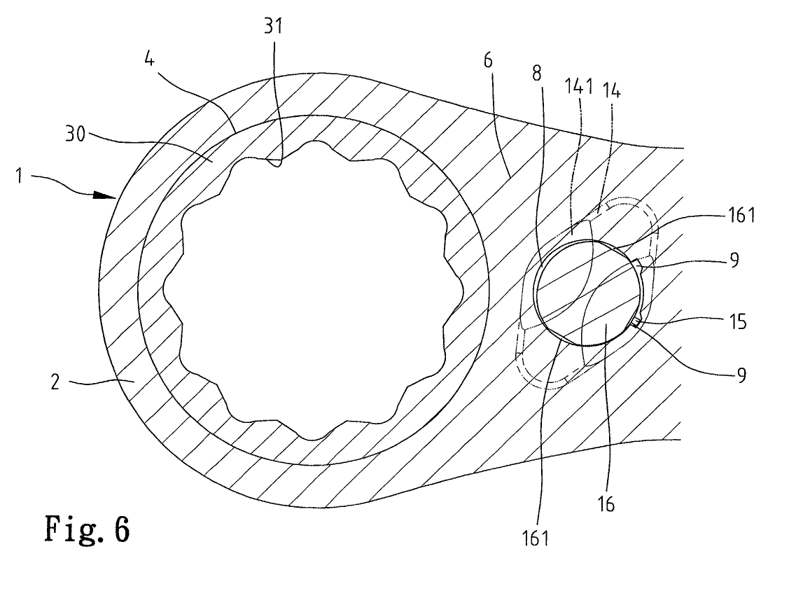

Referring to FIGS. 1 through 8 and initially to FIGS. 1, 2, 3, and 5, a ratchet-type wrench 10 in accordance with the present invention generally includes a handle 3 and a head 2 extended from the handle 3 and having a hole 2a. An inner periphery 4 defining the hole 2a of the head 2 includes an annular groove 5 in a lower portion thereof. A web 6 is defined between the head 2 and the handle 3. A cavity 7 is defined in the web 6. Also defined in the web 6 is a receiving hole 8 that is communicated with the cavity 7. The receiving hole 8 is substantially cylindrical and extends along an axis that is perpendicular to a longitudinal direction of the handle 3. Two positioning notches 9 are defined in an inner periphery defining the receiving hole 8, which will be described in detail later.

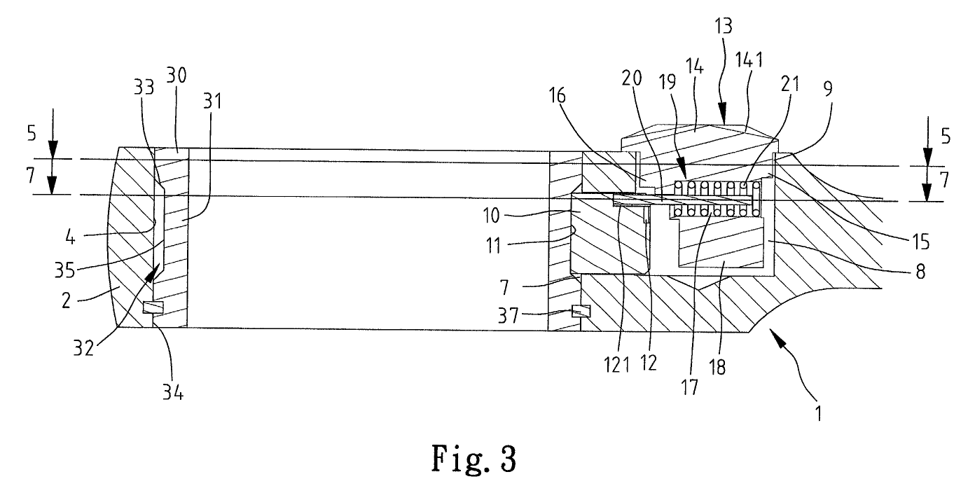

A drive member (in the form of a gear wheel 30 in this embodiment) is mounted in the head 2 and includes an inner periphery 31 for driving a fastener (not shown) and an outer periphery 32. The outer periphery 32 of the gear wheel 30 includes an upper end portion 33, a lower end portion 34, and a middle portion with a plurality of recessed teeth 35. The lower end portion 34 includes an annular groove 36. A C-clip 37 is received in the annular groove 36 of the lower end portion 34 and the annular groove 5 of the head 2, thereby rotatably retaining the gear wheel 30 in the head 2 of the wrench 1, best shown in FIG. 3.

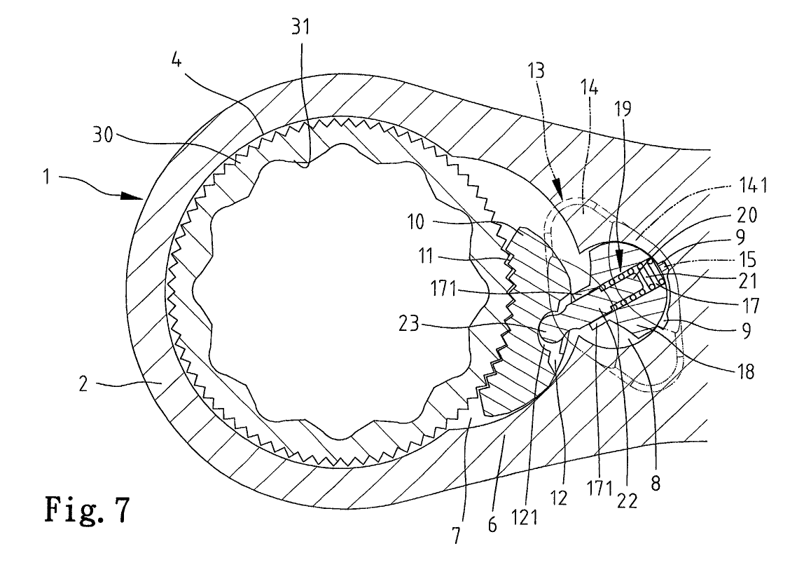

A pawl 10 is mounted in the cavity 7 in the web 6 and includes ratchet teeth 1 on a side thereof for engaging with teeth 35 of the gear wheel 30. The other side of the pawl 10 further includes a recess 12. As illustrated in FIG. 7, an inner wall defining the recess 12 includes an arcuate groove 121 defined therein, which will be described later.

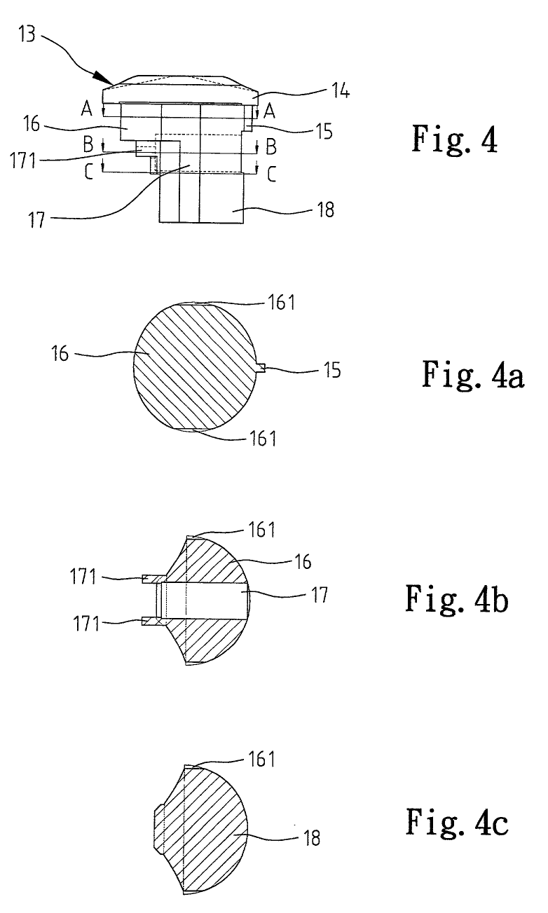

Still referring to FIGS. 1 through 3 and further to FIGS. 4a through 4c, a switch member 13 is rotatably mounted in the receiving hole 8. In this embodiment, the switch member 13 includes a substantially rhomboid turn-piece 14 outside the receiving hole 8 for manual operation and a positioning section 16 extending from the turn-piece 14 and having a positioning member 15. Two recessed portions 141 are defined in a top face of the turn-piece 14 to allow easy operation for the user's fingers. The positioning member 15, as illustrated in FIG. 4a, is a protrusion projecting from the positioning section 16. The positioning section 16 is trimmed at two opposite sides thereof to form two flat faces 161 that are substantially parallel to each other. Thus, in addition to rotational movement, the positioning section 16 is slidable in the receiving hole 8 by a relatively small distance, which will be described in detail later. As illustrated in FIG. 4b, a switching section 18 is provided below the positioning section 16 and includes a receptacle 17 and a pair of reinforcing pieces 17 projecting outward from an area that surrounds an end of the receptacle 17. The switching section 18 is shorter than the positioning section 16 and includes a stepped structure, as shown in FIGS. 3 and 4.

A biasing/actuating means 19 includes an actuating member 20 and an elastic member 21. The actuating member 20 has a wider middle portion 22 to which an end of the elastic member 21 is attached. An end 24 of the actuating member 20 around which a portion of the elastic member 21 is mounted is received in the receptacle 17 of the switching section 18 of the switch member 13 with the middle portion 22 of the actuating member 20 being covered by the reinforcing pieces 171. Namely, the reinforcing pieces 17 restrain movement of the end 24 of the actuating member 20 even if the end 24 is exposed outside the receptacle 17. The other end 23 of the actuating member 20 is round and is engaged in the arcuate groove 121 of the recess 12 of the pawl 10. Thus, the pawl 10 is moved via transmission by the actuating member 20 when the switch member 13 is turned, thereby changing the ratcheting direction of the wrench.

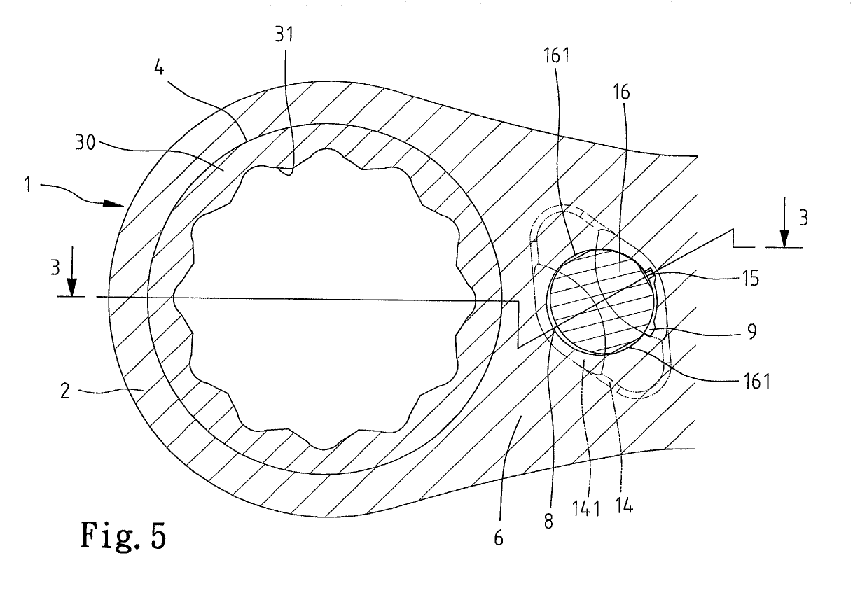

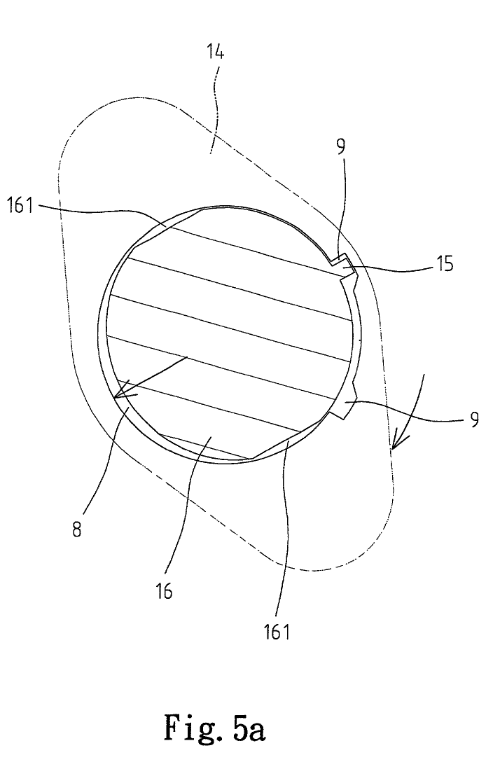

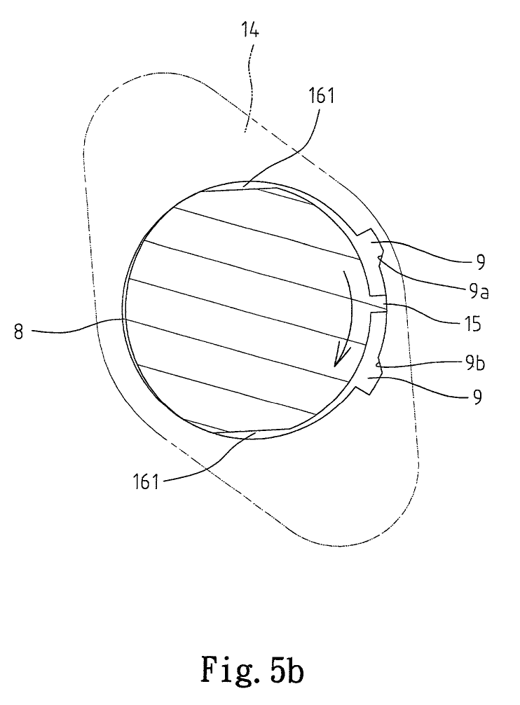

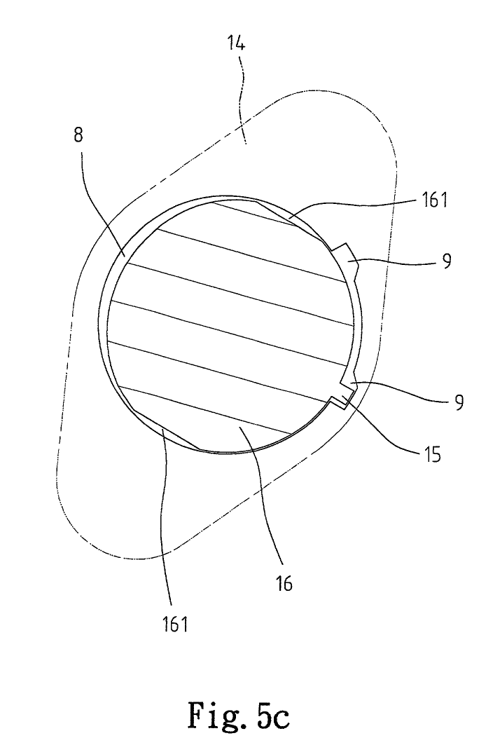

The ratchet-type wrench shown in FIGS. 3, 5, and 7 is in a status allowing clockwise ratcheting (free rotation in counterclockwise direction), in which the positioning member 15 is received in one of the notches 9 (the upper one in FIG. 5) and the round end 24 of the actuating member 20 is received in the arcuate groove 121 of the recess 12 of the pawl 10. Thus, a side face (not labeled) of the pawl 10 bears against the lower wall surface of the cavity 7.

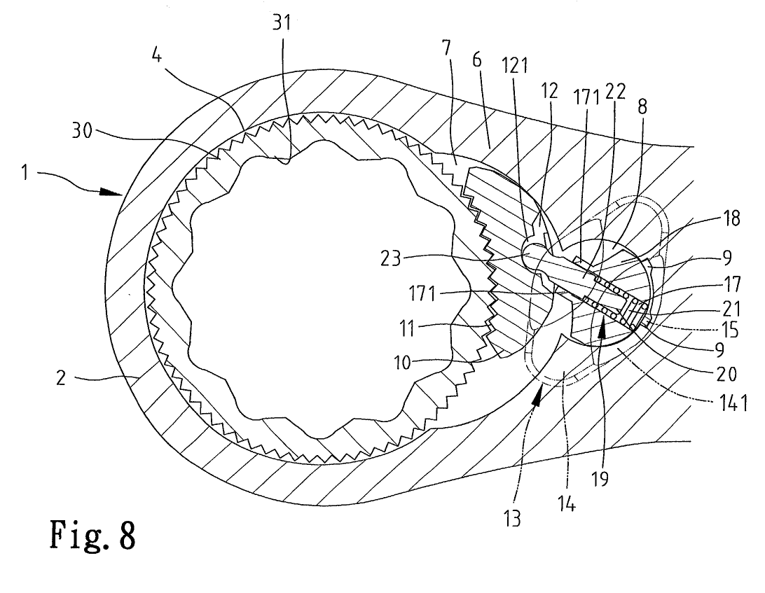

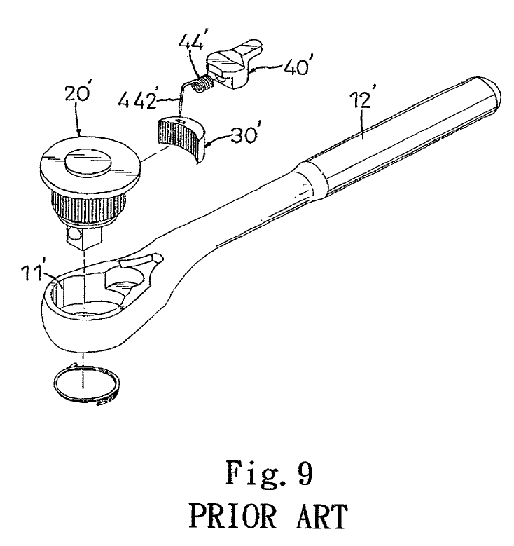

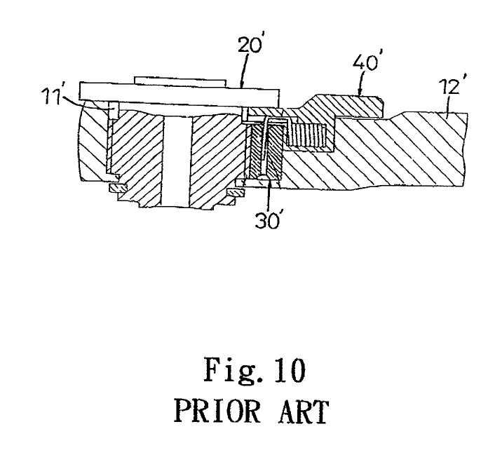

When the turn-piece 14 is turned clockwise for changing the ratcheting direction, the elastic member 21 is compressed and the positioning member 15 is moved out of the notch 9 and moved toward the other notch 9 as illustrated in FIG. 5b. The flat sides 161 of the positioning section 16 of the switch member 13 allow slight sliding of the positioning section 16 in the receiving hole 8. When the positioning member 15 reaches the other notch 9 (FIG. 5c), the elastic member 21 returns to its initial state to retain the positioning member 15 of the positioning section 16 in place. In addition, as illustrated in FIG. 8, the round end 23 of the actuating member 20 of the biasing/actuating means 19 is extended into the arcuate groove 121 of the recess 12 of the pawl 10, and the pawl 10 is moved to an upper side of the cavity with another side face (not labeled) of the pawl 10 bearing against the upper wall surface of the cavity 7. Change in the ratcheting direction of the wrench is thus completed. It is noted that each positioning notch 9 includes an inclined section 9a, 9b (FIG. 5b) adjacent to the other positioning notch 9 to guide the positioning member 15 out of one of the positioning notches 9 and then into the other positioning notch 9.

Although the invention has been explained in relation to its preferred embodiment, it is to be understood that many other possible modifications and variations can be made without departing from the scope of the invention as hereinafter claimed.

What is claimed is:

1. A reversible ratchet-type wrench comprising:
a handle;
a head extended from the handle and having a hole, a web being defined between the handle and the head, the web including a cavity communicated with the hole of the head and a receiving hole communicated with the cavity, an inner periphery defining the receiving hole including a first positioning notch and a second positioning notch;
a drive member rotatably mounted in the hole of the head and including a plurality of teeth defined in an outer periphery thereof;
a pawl mounted in the cavity and including a first side facing the hole of the head and a second side facing away from the hole of the head, the first side of the pawl including a plurality of teeth for meshing with the teeth of the drive member;
a switch member including a turn-piece outside the receiving hole of the web for manual operation, the switch member further including a positioning section extending from the turn-piece and a switching section extending from the positioning section, the positioning section being rotatably received in the receiving hole of the web and having a positioning member retained in one of the first positioning notch and the second positioning notch of the receiving hole of the web, the turn-piece being movable to move the positioning member into one of the first positioning notch and the second positioning notch; and
a biasing/actuating means having a first end attached to the positioning section of the switch member and a second end attached to the second side of the pawl for biasing the teeth of the first side of the pawl to engage with the teeth of the drive member;
wherein when the positioning member is retained in the first positioning notch of the receiving hole of the web, the wrench allows ratcheting in a first direction, and when the positioning member is retained in the second positioning notch of the receiving hole of the web, the wrench allows ratcheting in a second direction that is reverse to the first direction.

2. The reversible ratchet-type wrench as claimed in claim 1, wherein the receiving hole is a cylindrical hole extending along a direction that is perpendicular to a longitudinal axis of the handle.

3. The reversible ratchet-type wrench as claimed in claim 1, wherein the second side of the pawl includes a recess, an inner wall defining the recess including an arcuate groove for receiving the second end of the biasing/actuating means.

4. The reversible ratchet-type wrench as claimed in claim 3, wherein the biasing/actuating means includes an actuating member and an elastic member, the actuating member having a wider middle portion, a first end, and a second end, the elastic member including a first end attached to the first end of the actuating member and a second end attached to the switching section of the switch member, the second end of the actuating member being biased by the elastic member into the arcuate groove of the pawl.

5. The reversible ratchet-type wrench as claimed in claim 4, wherein the second end of the actuating member is round.

6. The reversible ratchet-type wrench as claimed in claim 4, wherein the switching section of the switch member includes a receptacle for receiving the second end of the elastic member.

7. The reversible ratchet-type wrench as claimed in claim 6, further comprising two reinforcing pieces projecting outward from an area that surrounds an end of the receptacle, the middle portion of the actuating member being guided between the reinforcing pieces.

8. The reversible ratchet-type wrench as claimed in claim 1, wherein the positioning section of the switch member includes two opposite flat sides to allow slight sliding movement of the switch member in the receiving hole of the web.

9. The reversible ratchet-type wrench as claimed in claim 2, wherein the positioning section of the switch member includes two opposite flat sides to allow slight sliding movement of the switch member in the receiving hole of the web.

10. The reversible ratchet-type wrench as claimed in claim 3, wherein the positioning section of the switch member includes two opposite flat sides to allow slight sliding movement of the switch member in the receiving hole of the web.

11. The reversible ratchet-type wrench as claimed in claim 4, wherein the positioning section of the switch member includes two opposite flat sides to allow slight sliding movement of the switch member in the receiving hole of the web.

12. The reversible ratchet-type wrench as claimed in claim 5, wherein the positioning section of the switch member includes two opposite flat sides to allow slight sliding movement of the switch member in the receiving hole of the web.

13. The reversible ratchet-type wrench as claimed in claim 6, wherein the positioning section of the switch member includes two opposite flat sides to allow slight sliding movement of the switch member in the receiving hole of the web.

14. The reversible ratchet-type wrench as claimed in claim 7, wherein the positioning section of the switch member includes two opposite flat sides to allow slight sliding movement of the switch member in the receiving hole of the web.

15. The reversible ratchet-type wrench as claimed in claim 1, wherein each of the two positioning notches includes an inclined section adjacent to the other positioning notch to guide the positioning member out of one of the positioning notches and then into the other positioning notch.

16. The reversible ratchet-type wrench as claimed in claim 1, wherein an inner periphery defining the hole of the head includes an annular groove, the outer periphery of the drive member including an annular groove, further comprising a C-clip received in the annular groove of the head and the annular groove of the drive member, thereby rotatably mounting the drive member in the head.

17. The reversible ratchet-type wrench as claimed in claim 16, wherein the drive member is a gear wheel.

18. The reversible ratchet-type wrench as claimed in claim 16, wherein the drive member is a gear wheel.
